(19) United States
(12) Patent Application Publication
(10) Pub. No.: US 2014/0121017 A1
(43) Pub. Date: May 1, 2014

(54) SYSTEMS AND METHODS FOR CONTROLLING USER INTERACTION WITH BIOFEEDBACK GAMING APPLICATIONS

(71) Applicant: UNIVERSITY OF SASKATCHEWAN, Saskatoon (CA)

(72) Inventors: Regan Mandryk, Saskatoon (CA); Shane Dielschneider, Saskatoon (CA); Michael Kalyn, Saskatoon (CA); Andre Doucette, Saskatoon (CA)

(73) Assignee: UNIVERSITY OF SASKATCHEWAN, Saskatoon (CA)

(21) Appl. No.: 13/660,469

(22) Filed: Oct. 25, 2012

(51) Int. Cl. A63F 13/00

(52) U.S. Cl. CPC A63F 13/00
USPC 463/36

(57) ABSTRACT

Systems and methods of controlling user interaction with an application. The systems and methods include executing an application, providing a graphical overlay coupled to the application where the graphical overlay is configured to display a visualization or a visual effect, measuring at least one engagement characteristic to provide a measured condition and providing the visualization based on the measured condition. Examples of engagement characteristic include user physiological condition, type of the application selected, duration of time spent interacting with the application, duration of time spent interacting with one or more input receiving devices, pressure exerted over one or more input receiving devices and noise level of the user.

### FIELD

The described embodiments relate to systems and methods for controlling user interaction with an application, and in particular, to systems and methods for controlling user interaction with biofeedback gaming applications.

### BACKGROUND

Applications such as biofeedback games help users maintain specific mental or physical states. For example, biofeedback games may help users to manage stress and anxiety and maintain focus. However, biofeedback games can be expensive and difficult to create. Typically, the biofeedback games alter the game mechanics (i.e., rules and procedures) based on the user's physiology. Accordingly, biofeedback games are a custom creation making it difficult for the user to choose any off-the-shelf games as a biofeedback game.

Many biofeedback games are not sufficiently appealing to play and tend not to hold a users' interest over time. Typically, biofeedback games give users very little choice over which game genre to play or which physiological state to train. This can result in unsatisfactory user experiences.

### SUMMARY

In a first aspect, some embodiments of the invention provide a method of controlling interaction with an application. The method may comprise executing an application; providing a graphical overlay coupled to the application, the graphical overlay configured to display a visualization; determining a value for at least one engagement characteristic associated with interaction with the application; and providing the visualization based on the value of the at least one engagement characteristic. In some cases, the application is a video game application.

In some cases, the engagement characteristic is a physiological condition of a user interacting with the application. In some other cases, the engagement characteristic is the type of the application.

In some cases, the engagement characteristic is the duration of time spent interacting with the application. In some other cases, the engagement characteristic is the duration of time spent interacting with one or more input receiving devices.

In some further cases, the engagement characteristic is the pressure exerted over one or more input receiving devices to interact with the application.

In some cases, the engagement characteristic is a user noise level while interacting with the application.

In various cases, the graphical overlay is a transparent overlay and the visualization is provided by setting a visualization parameter in the graphical overlay. In some cases, the visualization parameters are shaders. In some other cases, the visualization parameters are selected from a group consisting of colormaps, noise textures and sprite sheets.

The method may further comprise receiving a target for the engagement characteristic, determining a deviation between the value for the engagement characteristic and the target, and providing a visualization based on the deviation.

In some cases, the visualization appearing on the graphical overlay is agnostic to the application. In some other cases, the visualization appearing on the graphical overlay is based on an application characteristic.

In some cases, the application characteristic is the theme of the application. In some other cases, the application characteristic is the genre of the application. In some further cases, the application characteristic is the visual style of the application.

In a second aspect, some embodiments of the invention provide an engagement feedback system for controlling interaction with an application. The system may comprise a client system configured to interaction with the application; a sensor system coupled to the client system and configured to measure a value for at least one engagement characteristic of the client system; and an engagement feedback server coupled to the client system and the second system, and configured to provide a graphical overlay coupled to the application, the graphical overlay configured to provide a visualization, and provide the visualization based on the value of the at least one engagement characteristic.

The engagement feedback server may be further configured to receive a target for the engagement characteristic, determine a deviation between the value of the engagement characteristic and the target, and provide the visualization based on the deviation.

In another aspect, some embodiments of the invention provide a biofeedback gaming system for controlling user interaction with a gaming application. The system may comprise a sensing module configured to receive a value for at least one physiological condition of the user interacting with the gaming application; and an overlay module configured to provide an initial graphical overlay coupled to the application and update the initial graphical overlay based on the value of the at least one physiological condition.

The biofeedback gaming server may be further configured to receive a target for the physiological condition, and the overlay module may be configured to determine a deviation between the value of the physiological condition and the target, and update the initial graphical overlay based on the deviation.

In some cases, the physiological condition is selected by the user. In some further cases, the gaming application is selected by the user.

### BRIEF DESCRIPTION OF THE DRAWINGS

Preferred embodiments of the present invention will now be described in detail with reference to the drawings, in which:

FIG. 1 is a block diagram of components interacting with a biofeedback gaming system in accordance with an example embodiment;

FIG. 2 is a block diagram of a biofeedback gaming server in accordance with an example embodiment;

FIG. 3 is an example embodiment of a table with fields related to the functionality of the sensing module;

FIG. 4 is a flowchart diagram illustrating an exemplary method for operation of an overlay module;

FIG. 5 is a flowchart diagram illustrating an exemplary method for operation of a biofeedback gaming system;

FIG. 6 is a flowchart diagram illustrating another exemplary method for operation of a biofeedback gaming system;

FIG. 7 is a flowchart diagram illustrating another exemplary method for operation of a biofeedback gaming system;

FIGS. 8A, 8B and 8C illustrate vine visualization effect during game play in accordance with an example implementation;

FIGS. 9A, 9B and 9C illustrate pulsing vein visualization effect during game play in accordance with an example implementation;

FIGS. 10A, 10B and 10C illustrate fiery portal visualization effect during game play in accordance with an example implementation;

FIGS. 11A, 11B and 11C illustrate mist visualization effect during game play in accordance with an example implementation;

FIGS. 12A, 12B and 12C illustrate wave visualization effect during game play in accordance with an example implementation;

FIGS. 13A, 13B and 13C illustrate frost visualization effect during game play in accordance with an example implementation;

FIGS. 14A, 14B and 14C illustrate animated sprite visualization effect during game play in accordance with an example implementation;

FIGS. 15A, 15B and 15C illustrate animated sprite visualization effect during game play in accordance with another example implementation; and

FIG. 16 is a block diagram of components interacting with an engagement feedback system in accordance with an example embodiment.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combinations thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The described embodiments may generally control user interaction or engagement with a computer application, such as, for example, a biofeedback gaming application. The systems and methods may provide a graphical overlay configured to display a visualization or a visual representation. The visualization may obfuscate elements of the underlying application based on various aspects of the user interaction with the underlying application.

In various embodiments, one or more physiological conditions of a user engaged in interaction with a computer application may be monitored. The systems and methods may customize visualizations to obscure elements of the underlying computer application based on the sensed physiological conditions. In some other embodiments, the systems and methods may customize the visualizations based on other aspects of user interaction with the underlying application, such as, for example, type of the application, duration of time spent interacting with the application, nature of the interaction etc.

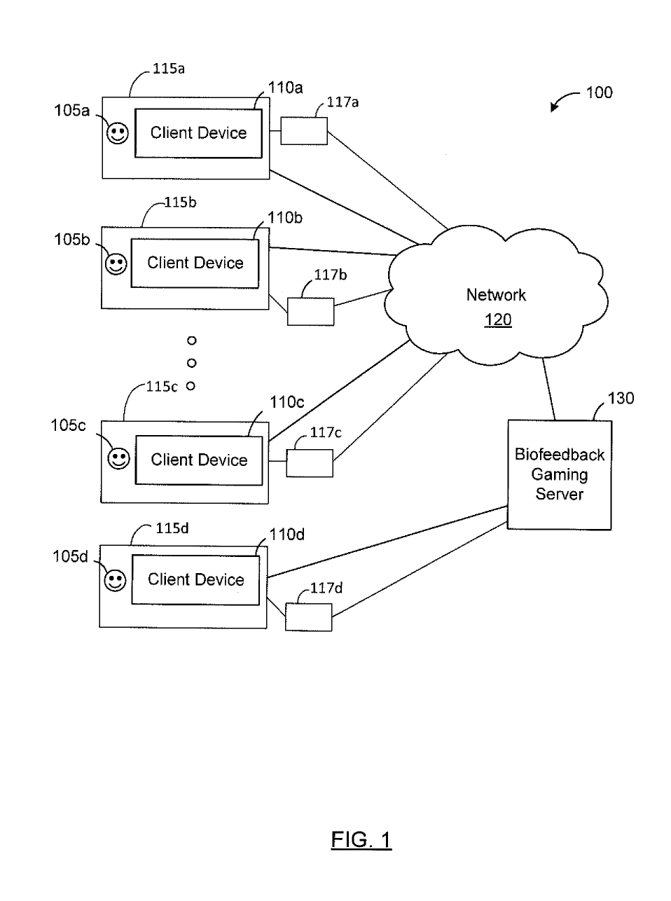

Reference is first made to FIG. 1, illustrating block diagrams of components interacting with a biofeedback gaming system 100 in accordance with an example embodiment.

Biofeedback gaming system 100 generally comprises one or more client systems 115a-115d, one or more sensor systems 117a-117d, a biofeedback gaming server 130 and network 120. Network 120 may connect one or more client systems 115a-c and one or more sensor systems 117a-117c to the biofeedback gaming server 130. In some cases, client system, such as client system 115d, may be directly connected to the biofeedback gaming server 130, for example, via a wired connection. Sensor system, such as sensor system 117d, may also be directly connected to the biofeedback gaming server 130. Each client system 115a-d comprises a client device 110a-d associated with a user 105a-d.

Network 120 may be any network capable of carrying data including the Internet, public switched telephone network (PSTN), or any other suitable local area network (LAN), wide area network (WAN), mobile data networks (e.g., Universal Mobile Telecommunications System (UMTS), 3GPP Long-Term Evolution Advanced (LTE Advanced), Worldwide Interoperability for Microwave Access (WiMAX), etc.) and combinations thereof.

Client device 110 may be any networked computing device comprising a processor and memory, such as a personal computer, workstation, server, portable computer, mobile device, personal digital assistant, laptop, smart phone, WAP phone, an interactive television, video display terminals, gaming consoles, an electronic reading device, and portable electronic devices or a combination of these. A networked device is a device capable of communicating with other devices through a communication network such as network 120. A network device may couple to the communication network through a wired or wireless connection.

In various embodiments, the client device 110 comprises a requesting client (not shown) which may be a computing application, application plug-in, a widget, instant messaging application, mobile device application, e-mail application, online telephony application, java application, web page, or web object stored and executed on the client device 110 in order communicate with other devices through a communication network.

The biofeedback gaming server 130 may comprise one or more servers with computing processing abilities and memory such as database(s) or file system(s). Although only one biofeedback gaming server 130 is shown for clarity, there may be multiple servers 130 or groups of servers 130 distributed over a wide geographic area and connected via, for example, network 120.

In some cases, the biofeedback gaming server 130 may comprise a gaming console and the client devices 110 may comprise game controllers for use with the gaming console. For example, the biofeedback gaming server 130 may be a Sony Playstation 3™, a Nintendo Wii™, a Microsoft XBOX 350™ or another such device or console such as a set-top television or satellite communication box or a computer. In other embodiments, the biofeedback gaming server 130 may be an Internet television or video service device such as an Apple TV™ and the client devices 110 may be devices capable of communicating with the television or video service devices such as Apple iPhones™, iPods™ or iPads™.

In some further cases, the biofeedback gaming server 130 and the client device 110 may be integrated into one device. For example, the biofeedback gaming server and the client device may be a personal computer equipped with input receiving devices, such as, for example, a mouse, a keyboard, a voice controlled application etc.

Biofeedback gaming server 130 may be any server that can provide access to computer applications, such as, for example, video games, to users 105. In some cases, the biofeedback gaming server 130 may store a wide selection of video games locally. In some other cases, the biofeedback gaming server 130 may be coupled to one or more servers, such as third-party servers, storing a wide selection of video games, and provide access to the applications by accessing these servers via, for example, network 120.

Biofeedback gaming server 130 may receive and process various inputs received from the users 105a-d. User inputs may include factors, such as, for example, type of game to play (e.g. World of Warcraft, Portal 2 etc.), part of the physiology to train (e.g. focus, body temperature etc.), physiology thresholds to maintain (e.g. theta/low beta ratio between 6-7.5 etc.), range of obfuscation (e.g. between 15-65 in week 1, between 25-85 in week 5 etc.) and type of obfuscation (e.g. shattered glass effect, ring of fire effect etc.) etc.

Biofeedback gaming server 130 may also receive physiological state of the user. In some cases, physiological state of the user may be received via sensor systems, such as, for example, sensor systems 117a-117d. In some other cases, the physiological state of the user may be manually monitored and provided to the biofeedback gaming server 130.

Sensor systems 117 may comprise one or more sensors, such as, for example, an electromyography sensor (EMG) for measuring electrical activation of muscle tissue, a respiration sensor (RESP) for measuring breathing rate and volume, a blood volume pulse sensor (BVP) for measuring blood flow through finger etc. Sensor systems 117 may also comprise sensor equipped devices, such as, for example, eye glasses equipped with a gaze tracking sensor.

In some cases, sensor systems 117 and the client devices 110 may be integrated into one device. For example, the client devices 110 may be configured with one or more sensors to monitor the physiological state of the user 105. In one example, client device 110, such as, for example, a smartphone device may be configured with a heart monitor sensor for measuring user heart rate. In another example, client device 110, such as, for example, a laptop may be equipped with a gaze tracking sensor for tracking the position and movement of user gaze on the display screen. In some other cases, sensor systems 117 may be coupled to the users 105. For example, users 105 may be equipped with one or more sensors or sensor equipped devices.

Biofeedback gaming server 130 may be configured to dynamically alter the interaction with the underlying application based on the sensed physiological state of the user. The dynamic change in user interaction or engagement with the underlying application may provide a real-time feedback to the user that the sensed physiology is outside the desired range. This may also motivate the user to train the sensed physiology and bring it within the desired range to continue the user experience without disruptions.

In various embodiments, the biofeedback gaming server 130 may provide graphical overlays on top of and separate from the underlying application. The graphical overlays may be customized to display visualizations as the user interaction progresses. For example, at a start of a gameplay, the graphical overlay may be a transparent overlay. As the gameplay progresses, the biofeedback gaming server 130 may dynamically alter the visualization appearing on the graphical overlay based on the user physiology. If the physiology being monitored is outside the desired range, the visualizations may make it increasingly hard for the user to progress in the game or have to a pleasant gaming experience.

The overlays may provide a wide variety of visualizations. For example, the overlays may provide visualizations, such as, for example, floating mist effect, crawling bugs effect, fire effect, waves effect, Gaussian blur effect, motion blur effect, refraction distortion effect, sketch rendering effect and abstract representations of the user's physiological state using variations in hue, contrast, symmetry, geometry and overall image entropy etc.

The visualizations may be multi-dimensional. For example, for a sprite effect visualization rendering particles, the particles may have multiple dimensions, such as, for example, spawn frequency, colour, spawn location, effect of gravity etc, One or more visualization dimensions may be simultaneously changed to provide feedback about one or more sensors, such as, for example, a respiration sensor and a heart sensor; more than one aspect of a single sensor, such as respiration rate and respiration volume aspects of the respiration sensor; or one or more physiological states of the user.

In some cases, the biofeedback gaming server 130 may be configured to provide generic visualizations that are agnostic to the underlying application. For example, the biofeedback gaming server 130 may provide a same floating mist effect for two or more different applications, such as a hockey game, a fantasy game etc., irrespective of the nature or genre of the applications.

In some other cases, the biofeedback gaming server 130 may provide visualizations consistent with the visual style, theme or genre of the underlying application. For example, in a video game application, a graphical overlay may provide a rain effect in a golfing game and a frost effect in an ice hockey game. By visually customizing the visualization to correspond to the underlying game, the graphical overlay and the underlying game may appear to be integrated. This may add to a pleasant user experience.

In some further cases, the biofeedback gaming server 130 may be configured to provide visualizations that interact with the underlying application. For example, biofeedback gaming server 130 may be configured to alter the user interaction with the underlying application by changing the speed of the user's avatar in a video game application. In another example, biofeedback gaming server 130 may be configured to alter the rules and procedures of the underlying game application. In a further example, biofeedback gaming server 130 may be configured to make the underlying application appear more cartoon-like by, for example, intercepting and processing signals from graphics card, using non-photorealistic rendering etc.

Biofeedback gaming server 130 may provide different visualizations for different stages of the same underlying application. For example, in a video game application, the biofeedback gaming server 130 may provide a first visualization for the first two levels of the video game and a second visualization for the next three levels of the video game.

The visualizations may also vary based on different locations in the underlying applications. For example, in a video game application, graphical effects used for indoor locations may differ from graphical effects used for outdoor locations.

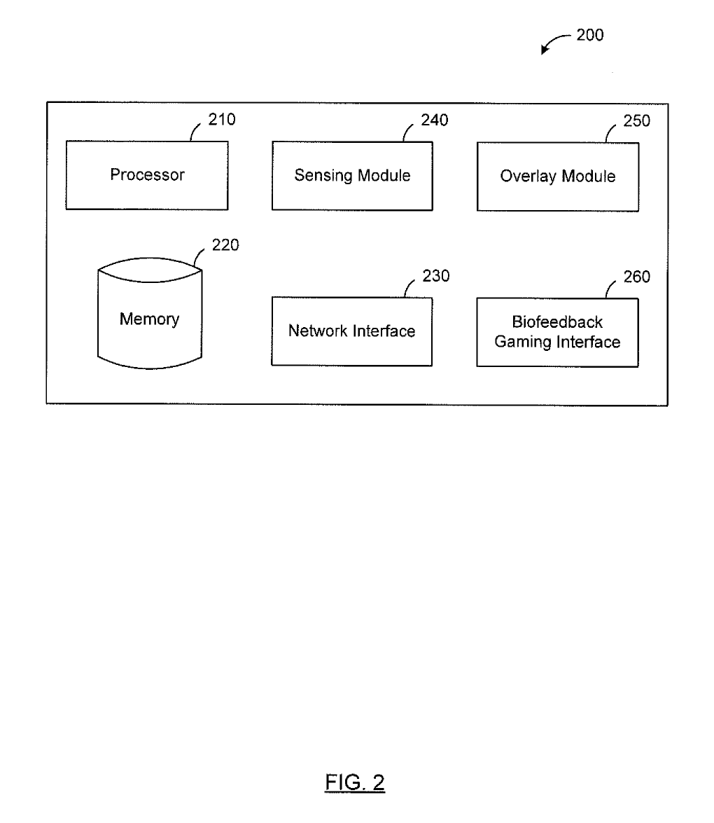

Reference is next made to FIG. 2, illustrating a simplified block diagram of a biofeedback gaming server 200 in accordance with an example embodiment. Biofeedback gaming server 200 may be similar to the biofeedback gaming server 130 of FIG. 1. Biofeedback gaming server 230 may comprise a processor 210, a memory 220, one or more network interfaces 230, a sensing module 240, an overlay module 250 and a biofeedback gaming interface 260.

Processor 210 may execute programs or instructions for operation of biofeedback gaming server 230 and may be any type of processor, such as, for example, any type of general-purpose microprocessor or microcontroller, a digital signal processing (DSP) processor, an application-specific integrated circuit (ASIC), a programmable read-only memory (PROM), or any combination thereof.

Memory 220 is a permanent storage associated with biofeedback gaming server 230 and may be any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

One or more network interfaces 230 may be configured to connect the biofeedback gaming server 230 to the network, such as network 120. The biofeedback gaming server 230 may communicate with other components in the system 100, such as client devices 110, sensor systems 117 etc., via the one or more network interfaces 230.

Sensing module 240 may be a storage and processing module that receives and processes user physiological information. Sensing module 240 may be configured to receive user psychological data from one or more sensor systems, such as, for example, sensor systems 117.

Sensing module 240 may be configured to process the user physiological data. Processing may comprise filtering, downsampling, smoothing, normalizing etc. of the sensed physiological data. For example, if the physiological data is measured with a BVP sensor, the sensed data may be downsampled by the sensing module 240.

In some cases, sensing module 240 may comprise digital filters, such as, for example, Chebyshev type II filters, for filtering the sensed data. Chebyshev type II filters may have low filter length and provide no ripple in the passband. This may provide low latency with minimum computation.

The sensing module 240 may be dynamically configured to receive physiological data from new sensor systems. For example, sensing module 240 may be managed by a multi-threaded library in C++ programming language that provides an interface with external sensor systems. Sensing module 240 may aggregate third-party software development kits (SDKs) into a single interface so third-parties can create sensor-dependent applications, regardless of the choice of hardware.

Sensing module 240 may be configured to provide the sensed and/or processed physiological data to the overlay module 250.

Overlay module 250 may be a storage and processing module that provides a graphical overlay for the underlying application and configures visualizations appearing on the graphical overlay. At the beginning of a game play, overlay module 250 may provide a transparent overlay allowing user inputs to the game play, such as keyboard and/or mouse events, to pass through to interact with applications running behind the overlay.

Overlay module 250 may be configured to receive physiological data from the sensing module 240. The physiological data may be the unprocessed sensed data, or processed data. Overlay module 250 may alter the visualizations appearing on the graphical overlay based on the measured physiological condition. For example, if the measured physiological state is within the desired range, then no change to the visualizations is made. If the measure physiological state is outside the desired range, the overlay module 250 may adjust the visualizations to obfuscate the underlying application.

In some cases, the overlay module 250 may be configured to penetrate the source code of the underlying application and alter the mechanics, such as, for example, the rules and procedures of the underlying application.

Overlay module 250 may be configured to change the visualizations based on a variety of factors. In some cases, the overlay module 250 may be configured to alter the visualizations based on the theme, genre or visual style of the underlying application. For example, in a video game application, a water ripple effect may be used with an underwater game.

The overlay module 250 may be configured to alter the visualization based on the narrative or the world of the application. For example, a fiery portal growing and shrinking to reveal the underlying display may be used with a fantasy game application.

In some other cases, the change in the visualization may be determined by the user. For example, the user may select a mist effect for the entire duration of the underlying game application. In some further cases, the change in the visualizations appearing on a graphical overlay may be pre-determined by the overlay module 250. For example, it may be pre-established that a shattered glass effect will be used to disrupt the underlying graphics at a first level of a video game application, and a motion blur effect at a second level of the video game application etc.

Overlay module 250 may be configured to provide any number of pre-packaged visualizations. Overlay module 250 may also customize the appearance of the visualizations by changing parameter values of the existing effects. For example, overlay module 250 may change parameters, such as colour and opacity, of a mist effect to provide a smoke effect. Parametric visualizations may allow visualizations to be varied and customized in an unlimited resolution without pre-defining a fixed number of states per visualization.

In some cases, the overlay module 250 may change the existing visualizations at run-time. In some other cases, overlay module 250 may change the existing effects at design time. The visualizations may be customized by altering resources, such as, for example, textures, colormaps etc. For example, texture and colormap parameters for a mud splatter effect may be changed to provide a blood splatter effect. In some further cases, overlay module 250 may provide new effects by implementing new shaders, such as, for example, vertex or pixel shaders.

In some cases, overlay module 250 may provide a tunnel vision effect. The tunnel vision effect may create a semi-transparent texture with a definable encroachment area on the screen. The location and size of the area, the fade-in threshold for the texture to become opaque, and the texture color may be modified to customize the effect.

Overlay module 250 may also provide a fractal noise effect. Fractal noise effect may use a noise texture to render semi-transparent textures. Multiple octaves of a noise texture (e.g. Perlin noise) may be used to create variations of the effect. The colour and the mean opacity may be modified to customize the effect.

In some cases, overlay module 250 may provide a waves effect. Waves effect may fill the screen with drops that generates ripples. The size and frequency of drops, the coordinates of the next drop, and the size and decay speed of the ripples may be modified to customize the effect.

In some other cases, overlay module 250 may provide a static sprite effect. Static sprite effect may render static 2D image sprites. The number, starting position (x, y coordinates), speed, acceleration, rotation speed and size of the sprites may be controlled to customize the effect. For example, overlay module 250 may create visual representations such as explosions by customizing the parameters of the static sprite effect.

Overlay module 250 may also provide animated sprite effect. Animated sprite effect may render animated 2D image sprites using a sprite sheet. The number, starting position, speed, acceleration, rotation and size of the sprites may be controlled to customize the effect.

Overlay module 250 may also provide more visualization effects by combining and customizing one or more of the already existing visualizations.

Biofeedback gaming interface 260 may be a graphical interface configured to provide and maintain tools and capabilities by which users 105 may submit inputs to the biofeedback gaming server 130. For example, the biofeedback gaming interface 260 may provide capabilities for users to select the type of application for user interaction, the choice of physiology to monitor and train, the desired or target physiology condition etc. The gaming interface is also configured to provide and maintain tools and capabilities to provide instructions, feedback, reports etc. to the user regarding their physiological state and/or game play etc.

Reference is next made to FIG. 3, illustrating an example embodiment of a table 300 with fields related to the functionality of the sensing module 240. Table 300 comprises a list of sensors 310 configured to sense and communicate user physiological data to the sensing module 240. Table 300 further comprises a list of devices 320a-c coupled to various sensors 310a-h, and a brief description 330 for each of the sensors 310a-h.

Sensor 310a is an electroencephalography sensor (EEG) for measuring 330a brain activity in multiple frequency bands. The sensor 310 may be coupled to a mindset device 320a, such as, for example, a Neurosky mindset. In some cases, data sensed or measured from an EEG sensor may be processed by the sensing module 240.

Sensor 310b is an eye gaze (Gaze) sensor for tracking 330b the location of user's gaze on the game screen. Gaze related data may include position and movement of gaze on the screen and pupil dilation. Gaze sensor may also record patterns and distributions of gaze fixations and saccadic eye motion. The Gaze sensor 310b may be coupled to an eye tracker device 320b, such as, for example, a Tobii eyetracker. In some cases, data measured from the Gaze sensor may be processed by the sensing module 240.

Sensor 310c is a blood volume pulse (BVP) sensor for measuring heart rate and monitoring relative blood flow. The BVP sensor 310c may be used to measure blood flow through user finger. Data measured from the BVP sensor may be downsampled by the sensing module 240. In some cases, the BVP sensor data may be downsampled 64 times. An electrocardiography (EKG) sensor may also be used for sensing user's heart activity.

Sensor 310d is a galvanic skin response (GSR) sensor for measuring 330d skin conductance. Data measured from a GSR sensor may be downsampled by the sensing module 240. For example, the GSR sensor data may be downsampled 64 times. An electrodermal activity (EDA) sensor may also be used for measuring skin-conductance levels.

Sensor 310e is a electromyography (EMG) sensor for measuring 330e the electrical activation of muscle tissue, such as, contraction of muscles. In some cases, data measured from EMG sensor may be downsampled by the sensing module 240. In some other cases, data measured from EMG sensor may be smoothed by the sensing module 240.

Sensor 310f is a respiration (RESP) sensor for measuring 330f breathing rate and volume. Sensor 310f may be coupled to a strap placed on a user's chest to measure amount of strain on the chest strap. Data measured from the RESP sensor may be processed by the sensing module 240 by, for example, normalizing, downsampling etc.

Sensor 310g is a temperature (TEMP) sensor for measuring temperature change. Temperature sensor 310g may be placed on surface of the skin. Data measured from the TEMP sensor may also be processed by the sensing module 240 by, for example, normalizing, downsampling etc.

Sensor 310h is a raw (RAW) sensor for receiving 330h data from any sensors manufactured by Thought Technology Ltd. (TTL). In some cases, data received from a raw sensor may be processed by the sensing module 240.

One or more of the sensors, such as, BVP, GSR, EMG, RESP, TEMP and RAW, may be coupled to an encoder, such as, for example, an encoder manufactured by TTL (e.g. ProComp2™ encoder etc.).

Table 300 is provided by way of an example only. Sensing module 240 may be configured to receive and process data from one or more of the sensors listed in the table. As previously mentioned, sensing module 240 may be dynamically configured to receive and process data from other third-party sensors.

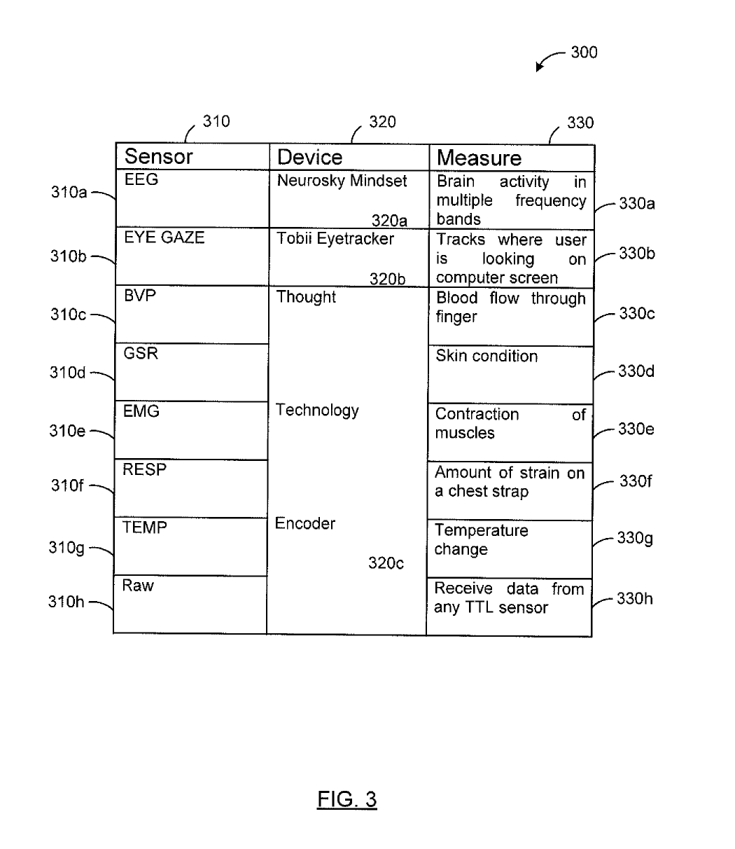

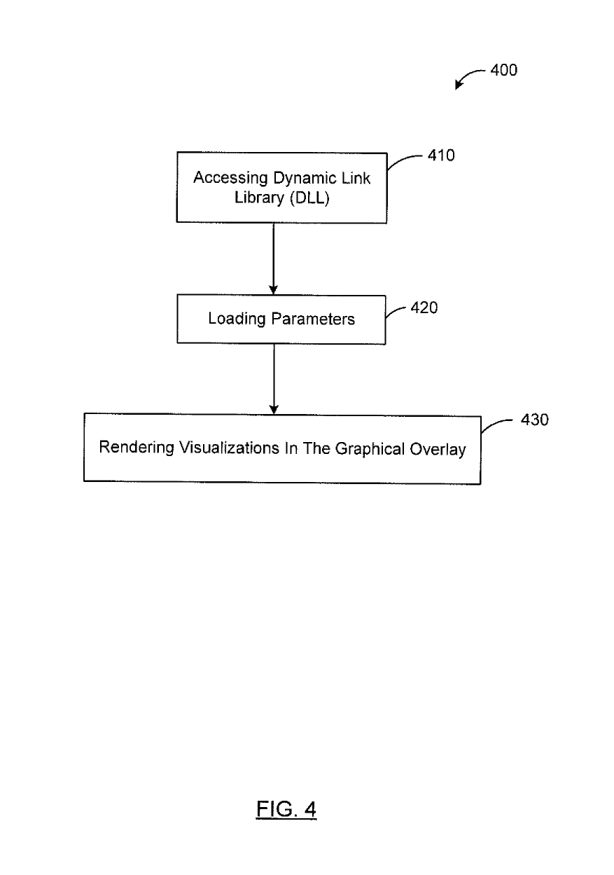

Reference is next made to FIG. 4, which is a flowchart diagram illustrating acts of a method 400 for the operation of an overlay module, such as the overlay module 250, in accordance with an example embodiment. Method 500 may be used by biofeedback gaming system 100, as described above with reference to the examples shown in FIGS. 1-3.

The various acts in the examples of the method 400 described below and shown in the Figures may be combined. For example, a new act described in relation to one example of the method 400 may be incorporated into a different example of the method 400 even if not explicitly stated.

In the example shown, the method 400 comprises accessing 410 a dynamic link library. In various embodiments, overlay module may access visualizations or visualization effects appearing on graphical overlays by including a library exported as a dynamic link library. A dynamic link library is a pre-compiled and executable collection of functions or data that can be loaded and used by any application during the execution of the application.

At 420, method 400 loads one or more parameters associated to the visualizations. The parameters may be stored in a parameter library or a file, such as, for example, an Extensible Markup Language (.XML) file. For a given visualization, the parameter library may define the types of parameters, values of the parameters etc. In some cases, each visualization may have between 3 and 32 parameters.

Overlay module 250 may provide a veins effect illustrating vein-like structures fading in from outer edges of the screen. Parameters corresponding to the veins effect may comprise veins color, fade-in location of the vein texture, location of the vein (e.g. x- and y-coordinates of the vein), size of the vein etc.

A flames effect illustrating areas filled with flames (orbs) may be provided by the overlay module 250. Parameters corresponding to the flames effect may comprise location of the flames, size of the flames, opacity of the flames etc.

Examples of parameters corresponding to a visualization illustrating a mist effect where a semi-transparent mist flows across the screen, may comprise color, opacity of the mist, amount of mist-free space surrounding the cursor, horizontal and vertical speeds of the flowing mist etc.

Examples of parameters corresponding to a visualization illustrating a droplets effect, where a screen fills with ripples that radiate from rain drops, may comprise size of the drops, size of the ripples, the x- and y-coordinates of the next drop, rate of falling drops etc.

In some cases, the parameters may be defined and reset based on the inputs received from the user. In some other cases, the parameters may be defined and reset based on inputs from an operator of the biofeedback gaming server. In some further cases, the parameters may be defined and reset based on pre-programmed instructions.

At 430, method 400 renders visualizations in the graphical overlay. A visualization or a visual representation may be rendered by setting or adjusting effect, such as, for example, a vertex or pixel shader, and one or more resources, such as, for example, colormaps, noise textures, sprite sheets etc, according to the loaded parameters. The effects may be defined in a .fx file written in, for example, a High Level Shader Language (HLSL). Resources may be defined in DirectDraw Surface (DDS) files.

In some cases, the visual representation may be rendered by adjusting the resource parameters, such as colormaps, textures etc. In some other cases, the visual representation may be rendered by adjusting the underlying shaders. In some further cases, the visual representation may be rendered by modifying the dynamic link library and defining new effects, resources and/or parameters.

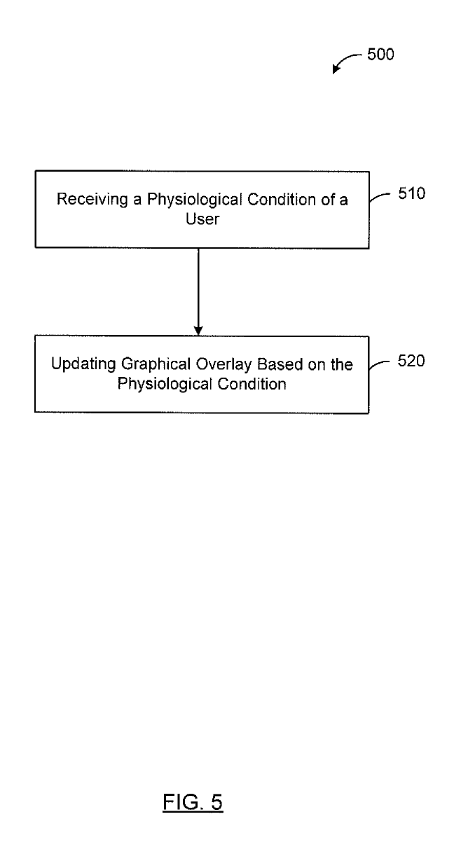

Reference is now made to FIG. 5, which is a flowchart diagram illustrating acts of a method 500 for the operation of a biofeedback gaming system in accordance with an example embodiment. It will be appreciated that many of the acts of the method 500 may be performed in a different order from the order in which they are shown in the figures and from the order in which they are described below. For example, some acts may be performed before the act they are shown to precede, and some method acts may be performed concurrently. Method 500 may be used by biofeedback gaming system 100, as described above with reference to the examples shown in FIGS. 1-4.

The various acts in the examples of the method 500 described below and shown in the Figures may be combined. For example, a new act described in relation to one example of the method 500 may be incorporated into a different example of the method 500 even if not explicitly stated.

In the example shown, the method 500 comprises receiving 510 one or more physiological conditions of a user, such as the user 105. The physiological condition may be received by a biofeedback gaming server, such as the biofeedback gaming server 130, and may be further processed. The physiological condition may be measured or sensed by one or more sensors devices, such as sensor systems 117, as discussed elsewhere in the application.

At 520, the biofeedback gaming server 130 may update the graphical overlay based on the received physiological condition. The graphical overlay may be updated to provide visualizations corresponding to the deviation of the received physiological condition from a desired range or value.

For example, if the received physiological condition is outside the desired range but within a first threshold, the graphical overlay may be updated to provide a first visualization. If the received physiological condition is outside the desired range and between the first and a second threshold, the graphical overlay may be updated to provide a second visualization.

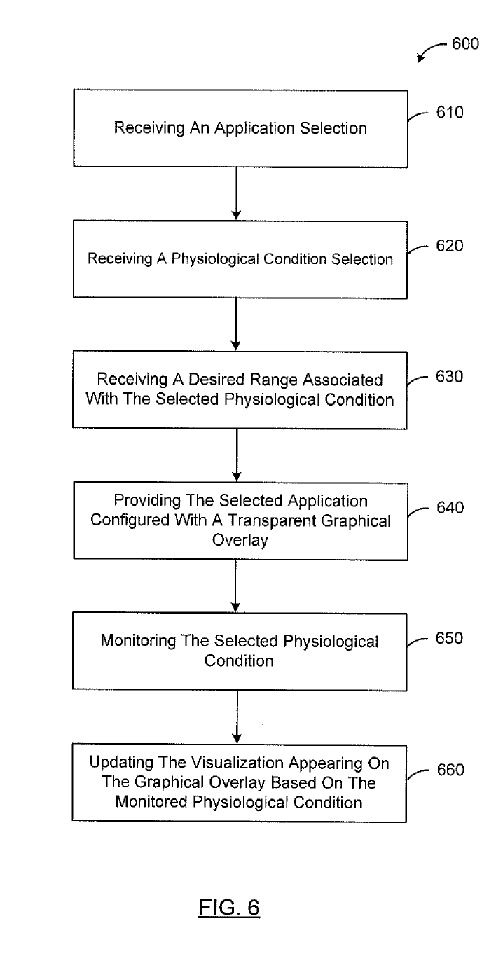

Reference is next made to FIG. 6, which is a flowchart diagram illustrating acts of a method 600 for the operation of a biofeedback gaming system in accordance with another example embodiment. It will be appreciated that many of the acts of the method 600 may be performed in a different order from the order in which they are shown in the figures and from the order in which they are described below. For example, some acts may be performed before the act they are shown to precede, and some method acts may be performed concurrently. Method 600 may be used by biofeedback gaming system 100, as described above with reference to the examples shown in FIGS. 1-5.

The various acts in the examples of the method 600 described below and shown in the Figures may be combined. For example, a new act described in relation to one example of the method 600 may be incorporated into a different example of the method 500 even if not explicitly stated.

In the example shown, the method 600 comprises receiving 610 a selection of an application that a user, such as the user 105, wants to interact with or engage in. The selection may be made by providing a list of accessible applications to the user and permitting the user to select the application of interest. For example, the user may be provided a list of video games and be permitted to make a selection.

Method 600 further comprises receiving 620 a selection of a physiology or a physiological condition to be monitored and trained. Example of physiological conditions may include breathing, muscle tension, hand temperature, heart rate, blood pressure and brain activity etc. In some cases, more than one physiological condition may be selected by the user.

At 630, method 600 comprises receiving 630 a desired range or a target value associated with the selected physiological condition. The desired range may be received as a minimum and maximum limit associated with the selected physiological condition. In some cases, a single value may be received as a target value for the selected physiological condition.

Method 600 further comprises providing 640 the selected application configured with a transparent graphical overlay to the user. The transparent graphical overlay may allow the user interactions with the underlying application to pass through. For example, the user may be able to view the underlying application without any disruptions and freely interact with the application.

At 650, method 600 comprises monitoring the selected physiological condition. Monitoring the physiological condition may comprise receiving the selected physiological condition of the user. Monitoring may also comprise processing by, for example, filtering, downsampling, the received physiological condition.

At 660, method 600 comprises updating the visualization appearing on the graphical overlay based on the monitored physiological condition.

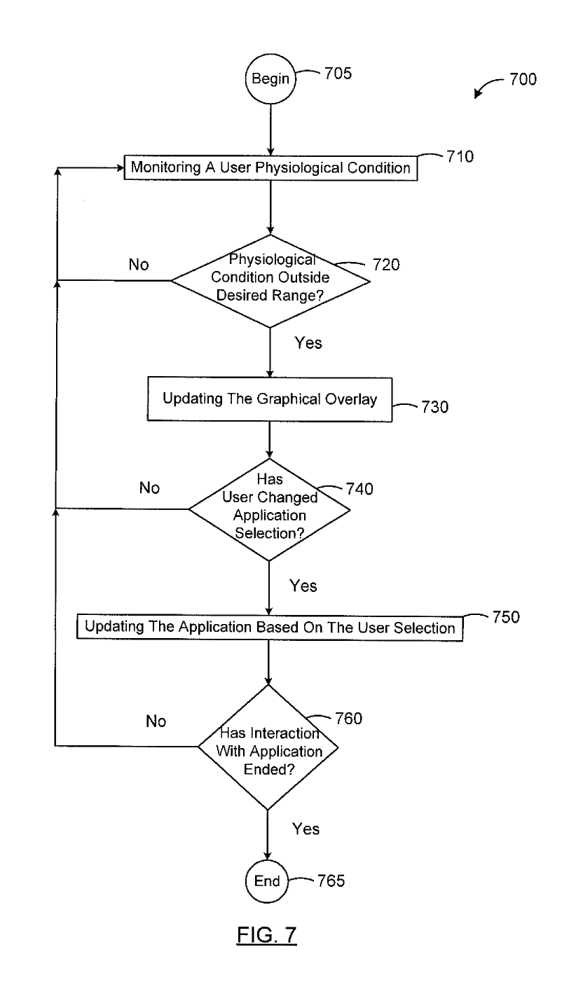

Reference is next made to FIG. 7, which is a flowchart diagram illustrating acts of a method 700 for the operation of a biofeedback gaming system in accordance with another example embodiment. It will be appreciated that many of the acts of the method 700 may be performed in a different order from the order in which they are shown in the figures and from the order in which they are described below. For example, some acts may be performed before the act they are shown to precede, and some method acts may be performed concurrently. Method 700 may be used by biofeedback gaming system 100, as described above with reference to the examples shown in FIGS. 1-6.

The various acts in the examples of the method 700 described below and shown in the Figures may be combined. For example, a new act described in relation to one example of the method 700 may be incorporated into a different example of the method 500 even if not explicitly stated.

Method 700 begins at 705. In the example shown, method 700 comprises monitoring 710 a user physiological condition. User physiological condition may be monitored by analyzing it in relation to the desired range or target value for the physiological condition.

Method 700 comprises determining at 720 whether the monitored physiological condition is outside the desired range. If the monitored physiological condition is within the desired range, then the monitoring of the user physiological condition continues at 710. However, biofeedback gaming server determines that the user physiological condition is outside the desired range, method 700 may proceed to 730.

Method 700 comprises updating 730 the graphical overlay based on the relationship between the monitored physiological condition and the desired range for that physiological condition. Biofeedback gaming server may configure visualizations appearing on the graphical overlay based on the extent to which the monitored physiological condition deviates from the desired range.

Method 700 further comprises determining 740 whether the application selection has been changed by the user. The application with which the user may want to engage in or interact with may be changed when the current application ends. In some cases, the application selection may be changed before the current application ends. For example, when engaging with a video game application, the application selection may change multiple times until the video game of interest is identified.

Method 700 proceeds to update the application based on the user selection at 750. In some cases, the biofeedback gaming server may provide generic visualizations and when the underlying application selection changes, the visualizations may not be changed. In some other cases, the biofeedback gaming server may change the visualizations based on the changes in the underlying applications. For example, the biofeedback gaming server may change the visualization to maintain consistency with the underlying theme, genre or visual effect of the newly selected application.

At 760, method 700 comprises determining whether the user interaction with the underlying application has ended. If the user interaction with the application has ended, method 700 ends at 765. Otherwise, method 700 continues to monitor the user physiological condition at 710.

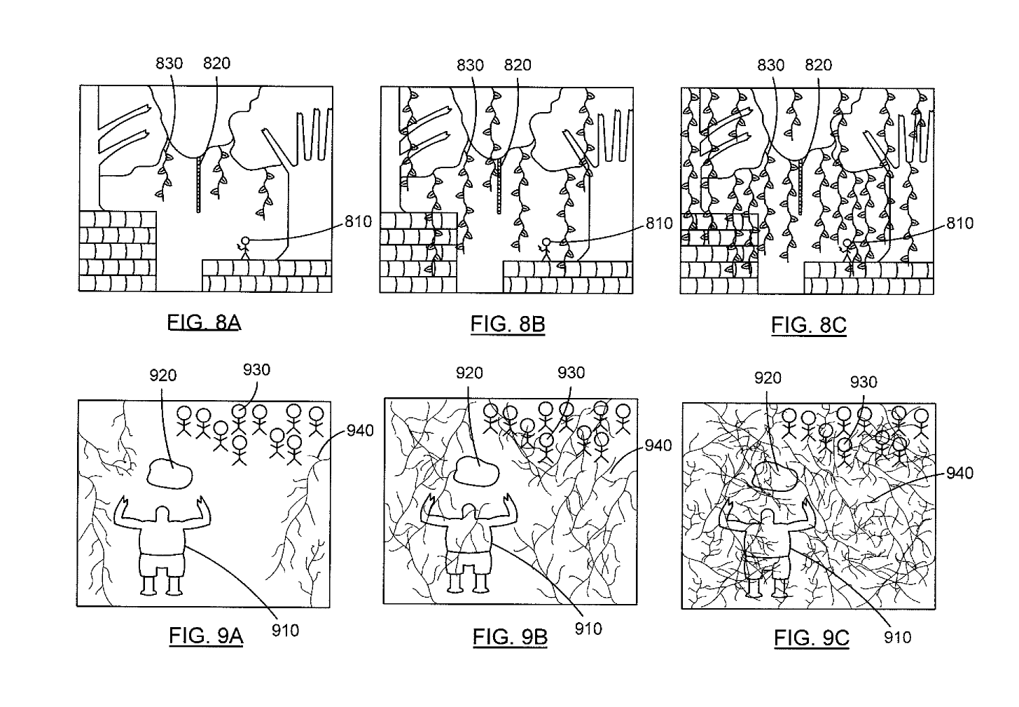

Reference is next made to FIGS. 8-15 illustrating visualizations appearing over graphical overlays in accordance with various example embodiments. FIG. 8 illustrates a graphical overlay generating a vine effect during user interaction with an underlying video game application. The underlying game, such as a jungle adventure game, illustrates an avatar 810 crossing a chasm using a rope 820. The game also illustrates vines 830. FIGS. 8A-8C illustrate changes in the graphical overlay visualizations based on the user physiological conditions. FIG. 8A illustrates a scenario where the user physiological condition is within the desired range and there are no disruptions in user's interaction with the underlying game.

FIGS. 8B and 8C illustrate an increase in the volume of vines 830 based on the extent to which the measured physiological characteristic of the user is outside the desired range. For example, if the measured physiological characteristic is outside a desired range but below a first threshold, then a small percentage of the underlying display is covered in vines, as in FIG. 8B. If the measured physiological characteristic is outside the desired range as well as outside the first threshold, then a larger percentage of the underlying display is covered in vines, as illustrated in FIG. 8C. By providing a visualization, such as the vine effect, consistent with the underlying visual aspect of the game, the graphical overlay and the underlying application appear integrated and may provide for an effective user experience.

By increasing the volume of the vines 830 in FIG. 8C, biofeedback gaming server obscures the graphics related to the underlying application, making it harder and less enjoyable to engage in the underlying application. As the physiological condition of the user is brought back towards or within the acceptable range, the visualizations appearing on the graphical overlay become less disruptive allowing the user to interact with the underlying application without much difficulty.

Reference is next made to FIGS. 9A-9C illustrating a graphical overlay configuring a pulsing vein visualization effect during game play. The underlying game, such as Incredible Hulk, illustrates an avatar 910 throwing a rock 920 at enemies 930 in a fight. The biofeedback gaming server may generate a pulsing vein effect 940 to deploy over the underlying game, as illustrated in FIG. 9A. FIGS. 9B and 9C illustrate the increase in the pulsing vein effect when the measured physiological characteristics of the user are outside the desired range disrupting the user interaction with the underlying game.

FIGS. 10A-10C illustrate a graphical display generating a fiery portal visualization effect 1020 during game play. The underlying game, such as the World of Warcraft, illustrates a plurality of avatars 1010 engaging in a combat. The fiery portal 1020 effect in FIG. 10A continues to narrow in FIGS. 10B and 10C based on the extent to which the measured physiological characteristic of the user is outside the desired range. As the difference between the measured physiological condition and the desired range increases, the fiery portal shrinks to disrupt the user interaction with the underlying game.

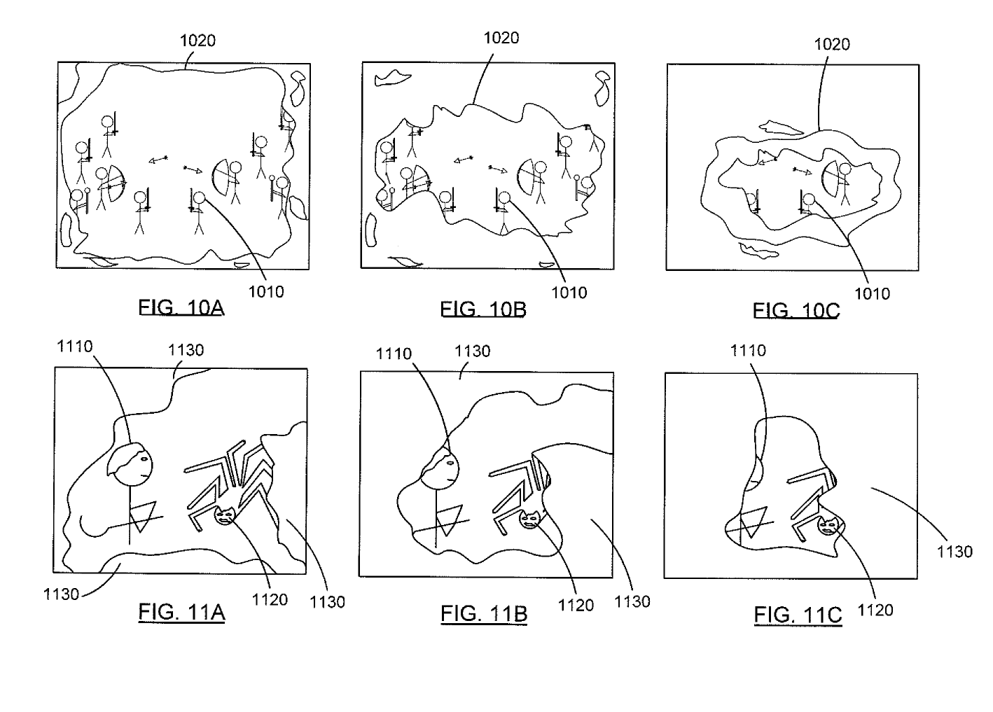

FIGS. 11A-11C illustrate a graphical overlay generating a mist effect 1130 during game play. The underlying game, such as a survival horror game, illustrates an avatar 1110 attempting to kill an enemy character 1120. As the user physiological condition continues to deviate from the desired range, the mist effect continues to increase and disrupt the user interaction with the underlying game application, as illustrated in FIGS. 11B and 11C.

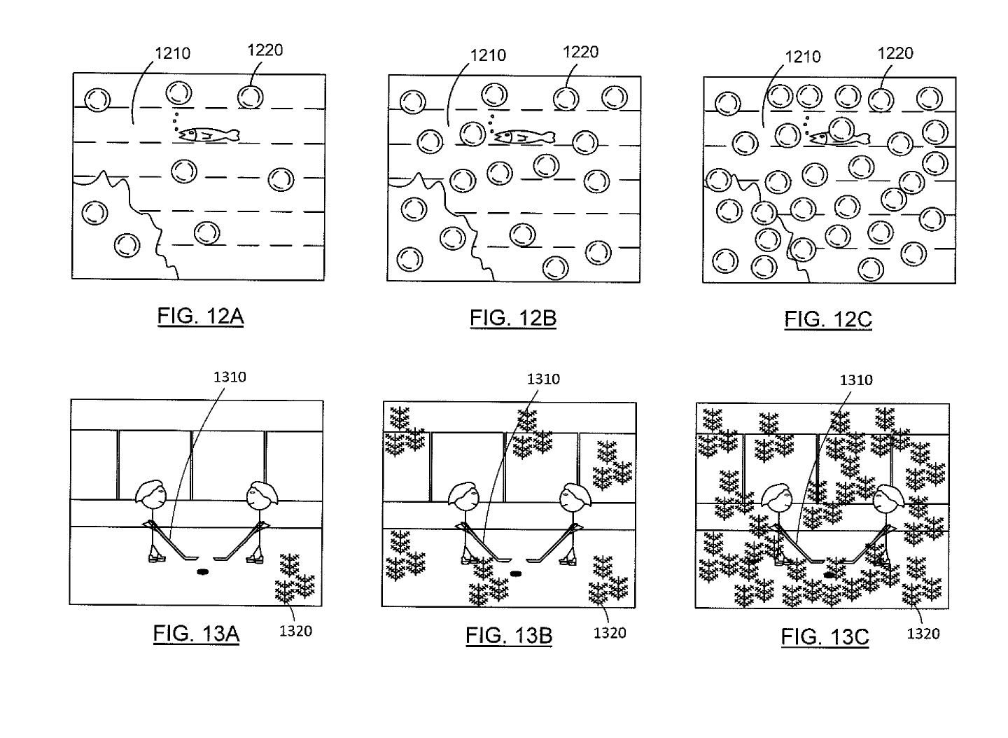

FIGS. 12A-12C illustrate a graphical overlay generating a waves effect 1220 during game play. The underlying game, such as spearfishing, illustrates an underwater scene 1210 including rocks, water and aquatic animal. As the measured physiological characteristic of the user continues to deviate from the desired range, the number of wave ripples 1220 continues to increase, as illustrated in FIGS. 12B and 12C.

FIGS. 13A-13C illustrate a graphical overlay generating a frost effect 1320 during game play. The underlying game, such as NHL, illustrates an avatar 1310 playing hockey with one or more other players. As the measured physiology deviates from the desired range, the frost effect 1320 increases, as illustrated in FIGS. 13A, 13B and 13C. Frost effect 1320 in FIG. 13C illustrates that the measured physiological condition of the user deviates heavily from the desired range, thereby making it very disruptive for the user to continue the game play. The user may consciously bring the physiological condition under control to be able to continue the game play with less or no disruptions.

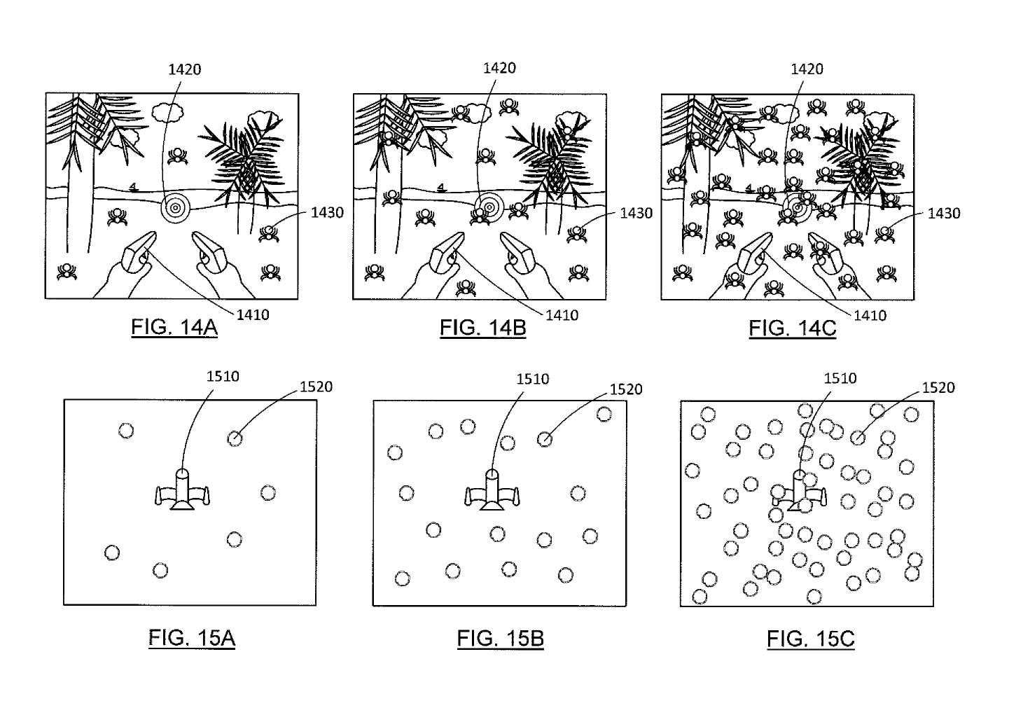

Reference is next made to FIGS. 14A-14C illustrating an animated sprite effect to render spiders 1430 during game play. The underlying game, such as a shooting game, illustrates an avatar 1410 aiming to shoot at target 1420. As the measured physiological condition of the user deviates from the desired range, the animated sprite effect increases to render more spiders crawling over the underlying game display making it very hard for the user to shoot the target, as illustrated in FIGS. 14B and 14C.

FIGS. 15A-15C illustrate a graphical overlay generating an animated sprite effect to render particles 1520 during game play. The underlying game, such as a space shooter game, illustrates a spacecraft 1510 and one or more particles 1520 in FIG. 15A. As the measured physiology deviates from the desired range, the animated sprite effect increases to render more particles on top of the underlying display, as illustrated in FIGS. 15B and 15C.

The biofeedback gaming server may also be configured to generate visualizations displaying a plurality of other effects. In some cases, the biofeedback gaming server may display a shattered glass effect, a mud splatter effect, a blood splatter effect, a cross-hatching effect, a water ripple effect, a motion blur effect etc. The biofeedback gaming server may generate visualizations combining one or more effects.

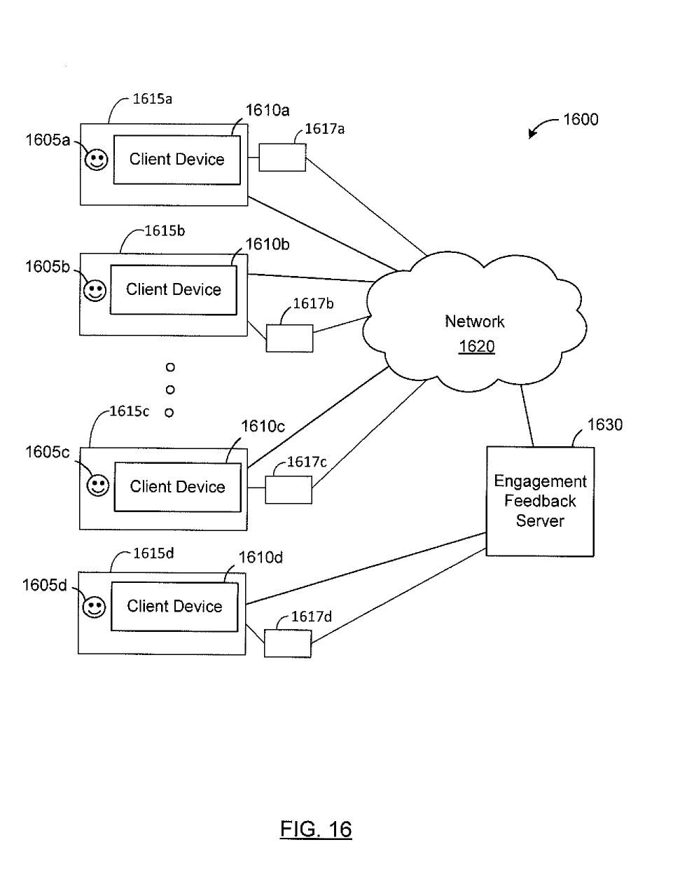

Reference is next made to FIG. 16 illustrating block diagrams of components interacting with an engagement feedback system 1600 in accordance with an example embodiment. Feedback system 1600 generally comprises one or more client systems 1615a-1615d, one or more sensor systems 1617a-1617d, an engagement feedback server 1630 and network 1620. Various components of the engagement feedback system 1600 may be similar to the components of biofeedback gaming system 100.

In this example embodiment, sensor systems 1617a-1617d may be configured to sense, detect or measure other aspects of user interaction or engagement with the underlying application. For example, sensor systems 1617 may monitor engagement characteristics such as, for example, the type of application selected, duration of time spent interacting with selected applications, pressure exerted over one or more input receiving devices while interacting with the underlying application, noise level of a user (by, for example, yelling, screaming etc.), or a combination of these etc.

The engagement feedback server 1630 may be configured to monitor the sensed aspects of the user interaction with the underlying application and provide disruptive visualizations to appear on a graphical overlay based on the deviation of the sensed aspects from the desired levels of interaction. For example, the engagement feedback server 1630 may be configured to monitor user interaction with certain social media websites, such as, for example, Twitter™, Facebook™ etc. Biofeedback gaming server 130 may be an engagement feedback server 1630 according to one example embodiment.

The engagement feedback server 1630 may receive aspects of user interaction from, for example, sensor systems 1617, such as the type of application selected by the user for interaction, duration of time spent interacting with the application etc.

The engagement feedback server 1630 may provide a mist visualization when the user interaction is detected to approach the desired quota associated with such applications. As the user interaction continues to near the quota, the mist may become thicker disrupting the user interaction with the underlying application. The mist visualization may fade away as the user switches to another application, or a website. There may be a cool down period associated with such applications and if the user returns to the social media application before the cool down period expires, the mist effect may return.

In another example, the engagement feedback server 1630 may be configured to monitor the amount of interaction the user has engaged in with input receiving devices, such as, a mouse, keyboard etc. By monitoring user interaction with mouse or keyboard or other input receiving device, repetitive strain injuries resulting from extended interaction with such devices may be avoided.

Engagement feedback server 1630 may receive amount of mouse or keyboard activity. This may be tracked by sensor systems 1617. Engagement feedback server 1630 may detect when the user interaction with input receiving devices is nearing the activity limit and provide visualizations, such as, flames visualization, to disrupt user interaction with the application.

In some other examples, the engagement feedback server 1630 may be configured to monitor the emotion expressed in text-based communications by monitoring the pressure exerted over the input receiving device, such as a keyboard.

Sensor systems 1617 may measure the pressure over all key presses very frequently and engagement feedback server 1630 may update the visualization accordingly. Engagement feedback server 1630 may provide veins visualization where the pulsating veins begin to grow as the pressure on the keys increases. In response to disruptive visualizations, the user may pause and carefully consider what was just written.

In another example, engagement feedback server 1630 may be configured to monitor user noise level and provide visualizations when the user noise levels exceed the desired range. For example, during game play, user may shout, cheer or yell obscenities. Sensor system 1617, for example a microphone, may be used to capture user noise levels.

Engagement feedback server 1630 may provide visualizations based on extent to which the noise level reaches a noise threshold. Visualizations, such as blur visualization, may be provided such that as the user's noise level reaches the noise threshold, the screen may be blurred making game play very difficult.

In some cases, the engagement feedback server 1630 may customize the visualization so they appear visually consistent and integrated with the theme of the underlying application. In some other cases, the engagement feedback server 1630 may provide generic visualizations irrespective of the underlying application.

The present invention has been described here by way of example only. Various modification and variations may be made to these exemplary embodiments without departing from the spirit and scope of the invention, which is limited only by the appended claims.

We claim:

1. A method of controlling interaction with an application, the method comprising:
executing an application;
providing a graphical overlay coupled to the application, the graphical overlay configured to display a visualization;
determining a value for at least one engagement characteristic associated with interaction with the application; and
providing the visualization based on the value of the at least one engagement characteristic.

2. The method of claim 1, wherein the application is a video game application.

3. The method of claim 1, wherein the at least one engagement characteristic comprises a physiological condition of a user interacting with the application.

4. The method of claim 1, wherein the graphical overlay is a transparent overlay and wherein the visualization is provided by setting a visualization parameter in the graphical overlay.

5. The method of claim 4, wherein the visualization parameter comprises shaders.

6. The method of claim 4, wherein the visualization parameter comprises resources selected from a group consisting of colormaps, noise textures and sprite sheets.

7. The method of claim 1, further comprising receiving a target for the at least one engagement characteristic, wherein providing the visualization comprises determining a deviation between the value for the at least one engagement characteristic and the target and providing the visualization based on the deviation.

8. The method of claim 1, wherein the visualization appearing on the graphical overlay is agnostic to the application.

9. The method of claim 1, wherein the visualization appearing on the graphical overlay is based on an application characteristic.

10. The method of claim 9, wherein the application characteristic comprises a theme of the application.

11. The method of claim 9, wherein the application characteristic comprises a genre of the application.

12. The method of claim 9, wherein the application characteristic comprises a visual style of the application.

13. The method of claim 1, wherein the at least one engagement characteristic comprises a type of the application.

14. The method of claim 1, wherein the at least one engagement characteristic further comprises a duration of time spent interacting with the application.

15. The method of claim 1, wherein the at least one engagement characteristic comprises a duration of time spent interacting with one or more input receiving devices.

16. The method of claim 1, wherein the at least one engagement characteristic comprises pressure exerted over one or more input receiving devices to interact with the application.

17. The method of claim 1, wherein the at least one engagement characteristic comprises noise level of a user interacting with the application.

18. An engagement feedback system for controlling interaction with an application, the system comprising:
a client system configured to interact with the application;
a sensor system coupled to the client system and configured to measure a value for at least one engagement characteristic of the client system; and
an engagement feedback server coupled to the client system and the sensor system, and configured to:
provide a graphical overlay coupled to the application, the graphical overlay configured to display a visualization; and
provide the visualization based on the value of the at least one engagement characteristic.

19. The engagement feedback system of claim 18, wherein the engagement feedback server is further configured to:
receive a target for the at least one engagement characteristic; and
determine a deviation between the value of the at least one engagement characteristic and the target;
wherein the visualization is provided based on the deviation.

20. The engagement feedback system of claim 18, wherein the graphical overlay is a transparent overlay and the engagement feedback server is configured to provide the visualization by setting a visualization parameter in the graphical overlay.

21. A biofeedback gaming system for controlling user interaction with a gaming application, the system comprising:
a sensing module configured to receive a value for at least one physiological condition of the user interacting with the gaming application; and
an overlay module configured to provide an initial graphical overlay coupled to the application and update the initial graphical overlay based on the value of the at least one physiological condition.

22. The system of claim 21, wherein the initial graphical overlay is transparent and the overlay module is configured to update the initial graphical overlay by defining visualization parameters in the initial graphical overlay.

23. The system of claim 21, further comprising a biofeedback gaming interface configured to receive a target for the at least one physiological condition, wherein the overlay module is further configured to determine a deviation between the value of the at least one physiological condition and the target, and update the initial graphical overlay based on the deviation.

24. The system of claim 23, wherein the biofeedback gaming interface is further configured to receive a selection of the at least one physiological condition by the user.

25. The system of claim 23, wherein the biofeedback gaming interface is further configured to receive a selection of the gaming application by the user.
